(19) United States
(12) Patent Application Publication
(10) Pub. No.: US 2010/0146523 A1
(43) Pub. Date: Jun. 10, 2010

(54) BROWSER ENVIRONMENT APPLICATION AND LOCAL FILE SERVER APPLICATION SYSTEM

(75) Inventors: Laurent Brigaut, St-Constant (CA); Francois Boissonneault, Montreal (CA); Stephane Joseph Daniel Claude Soucy, Repentigny (CA); Vahe Kassardjian, Mount-Royal (CA)

Correspondence Address: Anglehart et al., Suite 258, 393 St-Jacques, Montreal, QC, H2Y 1N9, CA

(73) Assignee: Tripod Ventures Inc./ Entreprises Tripod Inc., Montreal (CA)

(21) Appl. No.: 12/328,896

(22) Filed: Dec. 5, 2008

(51) Int. Cl. G06F 9/46

(52) U.S. Cl. 719/330

(57) ABSTRACT

A web browser environment allows an application to control a writing of files within a sandbox and prevents an application from controlling a writing of files outside the sandbox without using a predetermined browser environment file manager dialog box requiring user input to authorize a file write action. The browser application is allowed to have access outside the sandbox using calls to a server application, installed in the computer by user authentication for execution with access to files stored locally on the computer.

### TECHNICAL FIELD

The present invention relates to the field of computer browser environments that operate within a computer sandbox.

### BACKGROUND

A computer program application that runs within a browser environment, such as JAVA, ActiveX, Flash and JavaScript, offers advantages and disadvantages. Such applications can typically be loaded and executed without digital signature verification or user authentication. The user loads in the program from a web server, and thus updates to the program are controlled centrally by the server. Such applications are easy to deploy and use. They are trusted to run on a computer because the browser environment is within a sandbox on the computer, namely the browser environment does not allow the application direct access to the computer's memory or storage devices. Only memory within a reserved area, namely the sandbox, is directly accessible by the browser environment application. To access a file on the computer, the browser environment offers a dialog box to allow the use to access files outside of the sandbox. The primary disadvantage of such applications is this very lack of direct access by the application to the computer's storage.

### SUMMARY

It has been discovered that a browser environment application can exchange data with a local server application operating outside of the browser environment so that the browser environment application can have access to storage outside of the sandbox.

As a non-limiting example, a Flash application can exchange data through Remote Procedure Calls (RPCs) in blocks of up to 32 kb with an Adobe Integrated Runtime (AIR) application installed on the computer. The AIR application can act as a local file server. With the local server application installed once by the user with user authentication, a Flash application can be loaded into the browser and executed with access via the local server application to files outside of the browser sandbox.

A “client computer” can be a desktop or laptop computer, a netbook, a UMPC, a tablet, a PDA, a smartphone or any device that runs common operating systems such as Windows™, MaC™ OS, Linux and their variations. There is an upcoming trend towards “kitchen devices” (communication and entertainment systems, typically based on Linux and touch screens), and these likewise can be “client computers”.

In some embodiments, a client computer comprises a web browser environment configured to execute a web browser application in a programming language on the computer. The web browser environment allows an application to control a writing of files within a sandbox and preventing an application from controlling a writing of files outside the sandbox without using a predetermined browser environment file manager dialog box requiring user input to authorize a file write action. A server application is installed in the computer by user authentication for execution with access to files stored locally on the computer. The server application is configured to communicate with a predetermined web browser application to allow the predetermined web browser application to read and/or write files outside the sandbox on the computer. The web browser application is configured to execute file write commands for destinations within the sandbox using write commands within the web browser environment, to provide a view of files stored on the computer outside the sandbox without using the predetermined browser environment file manager dialog box, to receive user commands to read and/or write to files using the view of files, and to execute file read and/or write commands for destinations outside the sandbox by communication through the server application to perform file read and/or write operations outside the sandbox on the computer without using the predetermined browser environment file manager dialog box.

In some embodiments, the web browser application and the local server application communicate using a remote procedure call (RPC) protocol permitted by the web browser environment to pass data between the web browser application and the local server application. In some of these embodiments, data passed is in limited block sizes, and the browser application and the server application break down file transfers into blocks within a maximum block size permitted by the remote procedure call protocol and assemble the blocks transferred to provide the file. As a non-limiting example, the local server application can be an Adobe Integrated Runtime (AIR) application and the web browser application can be in Flash.

In some embodiments, the web browser application and the server application comprising multiple applications communicating using the RPC protocol, in which the remote procedure call (RPC) protocol includes an emergency channel, a first one of the multiple applications communicating using the RPC protocol that fails to communicate with the local server application switching to a server mode and informs a remainder of the multiple applications of the location of the new server using the emergency channel.

In some embodiments, the local server application is configured to execute on start-up of the computer.

In some embodiments, the web browser application is configured to detect a presence of the local server application, and to direct to a remote website to download installation files for the local server application when the presence of the server application is not detected.

In some embodiments, the web browser application is configured to store program code modules through the local server application on the computer outside the sandbox and to retrieve from the local server application the stored program code modules.

In some embodiments, the web browser application comprises a first module that is downloaded from a remote website and executed in the web browser to manage retrieval of the stored program modules, and downloads from the remote website program modules not stored on the computer outside the sandbox. The web browser application can be configured to execute a user interface program from at least one loaded module before loading other modules. These other modules can be loaded as required by execution of the web browser application. These other modules can all be loaded in the background while the at least one loaded module is executing.

In some embodiments, the server application is configured to prevent providing access to files outside of the sandbox to unauthorized applications running in the web browser environment.

In some embodiments, the web browser application is a photo editing and print order application for editing photo image files on the client computer and transmitting photo images over the Internet for printing at a remote printer location. The photo images can be resized to approximately the resolution of a final remote print prior to transmission from the client computer to the remote printer over the Internet. The photo images can be transmitted to the remote printer location with edit commands selected by a user. The server application can be configured to cause data of the photo images to be transmitted to the remote printer independently of the browser application.

In some embodiments, there is provided a network server system communicating with a client computer over the Internet, the server system configured to transmit to the client computer program code modules for putting into effect a web browser application and a server application according to any of the afore-mentioned embodiments.

### BRIEF DESCRIPTION OF THE DRAWINGS

The invention will be better understood by way of the following detailed description of embodiments of the invention with reference to the appended drawings, in which:

FIG. 1 is a schematic illustration of the browser environment and local file server system according to one embodiment;

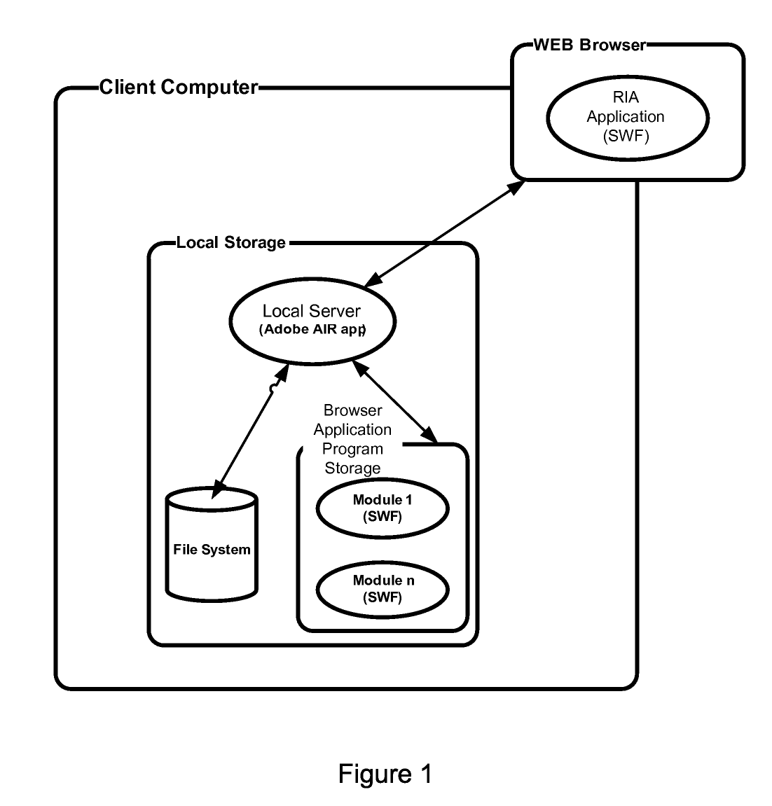

FIG. 2 is a screenshot of a file manager for a photo editing application according to one embodiment;

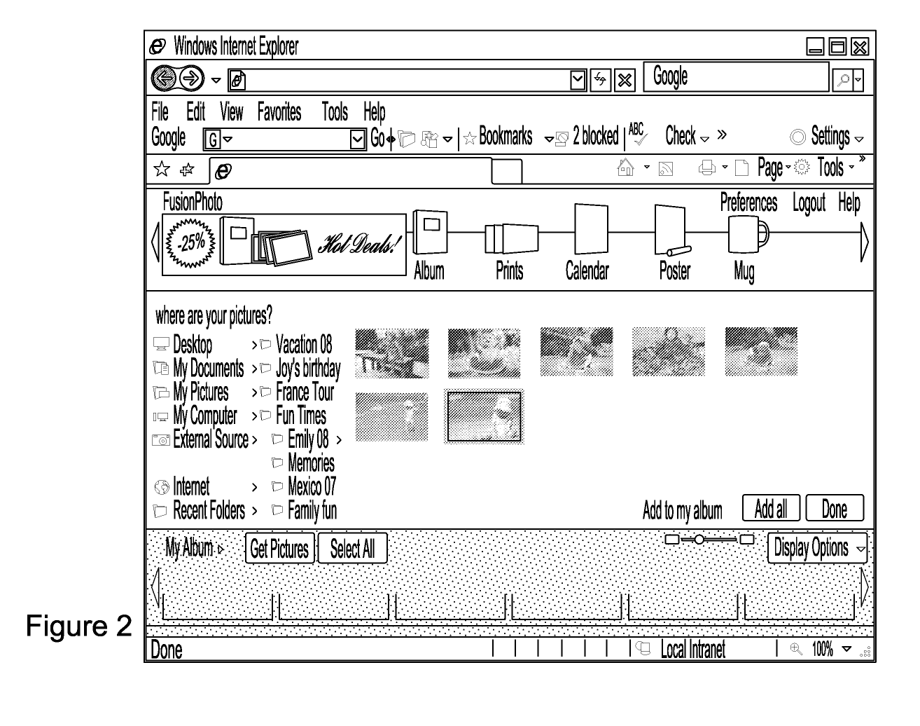

FIG. 3 is a flowchart illustrating the steps involved in accessing a file outside of the sandbox according to one embodiment; and

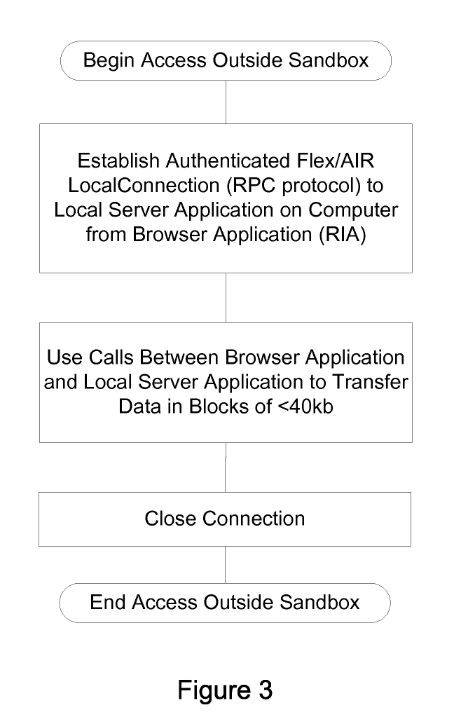

FIG. 4 is a flowchart illustrating the steps involved in running an application originating on a remote server according to one embodiment.

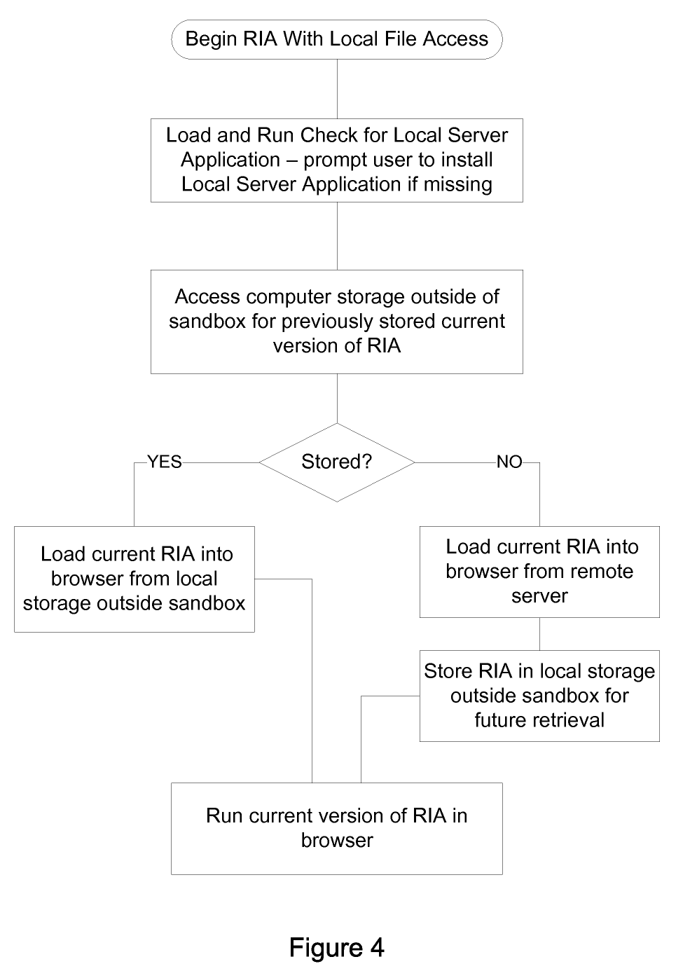

### DETAILED DESCRIPTION

In the following embodiments, the browser environment is Flash and the local file server browser-less application is AIR. Flash has the advantage over JAVA of uniformity, namely there are different JAVA environments that can lead to the same application executing differently. Flash can also be more compact and efficient for graphics. AIR also interfaces well with Flash.

The application in the following embodiments is a photo managing and editing application with a module to allow the user to order prints online from a photo developer/printer service, for example one associated with a local retailer, such as a drug store or grocery store.

The architecture for client architecture is meant to address the following issues:
Optimize bandwidth usage: in the context of an online photo rich Internet application (RIA), both download and upload time are challenging. RIA implies a rich user interface, therefore, one can easily assume that the size of the application will be non negligible (>2 Mb). The download time will become unbearable for users on the long run. On the other hand, working with digital photos brings the challenge of uploading time due to camera high resolution (a 6 MegaPixel camera produces 2 to 3 Mb jpeg files—this means a minimum of 15 minutes for 24 photos on a regular DSL connection working at 500 Kbits/s).
Overstep WEB browser security Sandbox: Web browsers protect computers using a security sandbox that prevent any script or application to access the computer file system outside the sandbox. To be able to resolve the bandwith optimization, one needs to overstep this limitation.
Support the vast majority of WEB browsers on 2 most popular OS's (MacOS X and Windows XP/Vista): the possible technologies to offer an online photo application today are Javascript, Java Applets, Netscape plugins, Firefox plugins, ActiveX or Flash. All the technologies except Flash are either OS/Browser specific (ActiveX, Firefox plugins) or complex to manage when comes the time to have a cross browser application (Javascript, Java Applets). Flash offers a perfect environment to solve this issue.

Architecture of the RIA relies on a two-tier architecture. The first tier is a lightweight shell component accessed from a web page. The second tier is a local server component that has to be installed on the client computer prior to using the RIA.

The RIA (1^{st} tier) relies on the local server component (2^{nd} tier) to handle the following key functionalities:
Accessing the local file system with no restriction
Intelligent caching of RIA modules.
Resizing photos to an optimal size based on the required prints size.
Uploading asynchronously the photo files.
Managing Internet connection losses.

The communication between 1^{st} and 2^{nd} tier is handled by a private protocol secured by encryption.

The local server is a desktop standalone application installed when the customer uses the RIA for the first time, therefore, this application does not suffer from the security limitations enforced by the web browser.

Once installed, the local server starts as soon as a user logs in on the computer allowing the RIA to indirectly access the local file system (reading and writing files).

When the RIA starts:
Checks for the presence of the local server.
If not present, downloads and ask the user to install it.
If present but not running, starts it and configures it, so it automatically starts next time the user logs in.
If present and running, it authenticates and has the local server ready to answer requests.

The RIA optimizes the bandwidth at 2 levels:
Caching of SWF modules locally;
Uploading resized photo files.

The RIA is split into multiple functional modules (size less or equal to 1 Mb). Aside from the shell application, all the modules are cached locally by the local server component. Upon a module request (name and version of the module required) from the RIA, the local server follows the procedure to
Check if the requested version of the module is present on the local file system.
If present, loads it and pass it to the RIA.
If not present (or wrong version), downloads it from the server and the feeds it to the RIA. In this case, the downloaded current version is then transferred to the local file system outside of the sandbox using the local file server.

The local server uploads photo files only once the order is confirmed by the customer, therefore the upload time can be optimized for the following reasons:
The server adjusts the dimension of the photo (+10% for antialiasing) according to the printed photo size required. For instance, a 6 megapixel camera takes 3000×2000 pixel photos when only 1320×1980 pixels are required to print at full resolution 4×6 prints.
The customer can change his mind and not include prints at the end. These prints will not be uploaded for no reason.

While the local server can transfer photo files to the RIA for transmission to the remote server (with or without performing additional processing), it will be appreciated that the local server can be provided with the ability to perform the necessary resizing and transmission to the remote server so that printing of the photos can be performed. Although the local server requires additional functionality to perform such tasks, an advantage is that the browser can be closed (thus terminating the operation of the RIA) after the user places an order for prints without affecting the local server's task of transmission of photo data to the remote server.

### Communication Protocol

To allow the Flex client application to exchange data with the AIR local server, a bidirectional communication protocol supporting large data transfer is used.

The technological constraints imposed by Flex/Air are:
Flex/Air offers an API (LocalConnection) to support inter process communication.
This protocol is a unidirectional RPC protocol.
This protocol allows only 40 Kb data transfer per RPC call.

Additionally, because it was chosen to use the MVC meta pattern architecture, the communication protocol was integrated into the low level of the MVC framework (PureMVC).

### Introduction to LocalConnection

LocalConnection is a unidirectional RPC protocol. An application (let's name it server) can decide to wait for RPC calls on a particular channel (identified by a unique ID). Any other application can trigger a call to a function in the server by calling a LocalConnection method providing the unique ID of the server, the name of the function to be called in the server and the parameters passed to that function. Low level communication protocol

The low level protocol is built on top of the LocalConnection protocol including the following functionalities:
Bidirectional communication: the protocol mimics the TCP/IP protocol where an application declares itself to be a server and listens on a specific channel (used only to listen for clients application requests for connection). When a client decides to request a connection, it sends a message to the server through the listening channel. Each application (client and server) creates a unique communication channel and informs the other application of it using the negotiation process described herein.
Support for large amount of data transfer: again, the protocol described here mimics the TCP/IP protocol. When data has to be sent from one application to another, the protocol transparently splits the message in smaller packets (max 40 kb) and sends one packet at a time using RPC calls. The receiving application rebuilds the packets before processing the message.

### MVC Meta-Pattern Introduction

The low level communication protocol architecture is built on top of a MVC (Model, View, Controller) architecture. The goal is to separate the architecture into uncoupled blocks: View (everything that pertains to user interface and interaction), Controller (business logic) and Model (data and domain logic). Blocks communicate together using notifications.

### Low Level Communication Protocol Integration

Integration of the low level protocol provides the following functionalities:
No dedicated server application: providing that a set of applications share a unique identifier used to establish a communication amongst them, the first application to start becomes the server and start listening for other applications to join the group.
Extension of the MVC notification mechanism: when an element of a block (Model, view or Controller) of an application sends a notification, the notification is sent both inside the application and to all the application connected.
Server crash protection: the protocol includes an emergency channel used to prevent losing the server. If the communication of the application that plays the server role quits (or crashes), the first client application that fails to communicate with the server, switches to the server mode and informs the rest of the group of the situation through the emergency channel. Communication then continues with a new one of the group of applications acting in server mode.

What is claimed is:

1. A client computer comprising:
a web browser environment configured to execute a web browser application in a programming language on said computer, said web browser environment allowing an application to control a writing of files within a sandbox and preventing an application from controlling a writing of files outside said sandbox without using a predetermined browser environment file manager dialog box requiring user input to authorize a file write action;
a server application, installed in said computer by user authentication for execution with access to files stored locally on said computer, said server application configured to communicate with a predetermined web browser application to allow said predetermined web browser application to read and/or write files outside said sandbox on said computer;
wherein said web browser application is configured to execute file write commands for destinations within said sandbox using write commands within said web browser environment, to provide a view of files stored on said computer outside said sandbox without using said predetermined browser environment file manager dialog box, to receive user commands to read and/or write to files using said view, and to execute file read and/or write commands for destinations outside said sandbox by communication through said server application to perform file read and/or write operations outside said sandbox on said computer without using said predetermined browser environment file manager dialog box.

2. The client computer as defined in claim 1, wherein said web browser application and said server application communicate using a remote procedure call (RPC) protocol permitted by said web browser environment to pass data between said web browser application and said server application.

3. The client computer as defined in claim 2, wherein said data passed is in limited block sizes, said browser application and said server application break down file transfers into blocks within a maximum block size permitted by said remote procedure call protocol and assemble said blocks transferred to provide said file.

4. The client computer as defined in claim 3, wherein said server application is an Adobe Integrated Runtime (AIR) application and said web browser application is in Flash.

5. The client computer as defined in claim 3, wherein said web browser application and said server application comprising multiple applications communicating using said RPC protocol, said remote procedure call (RPC) protocol includes an emergency channel, a first one of said multiple applications communicating using said RPC protocol that fails to communicate with said server application switching to a server mode and informs a remainder of said multiple applications of the location of the new server using said emergency channel.

6. The client computer as defined in claim 1, wherein said server application is configured to execute on start-up of said computer.

7. The client computer as defined in claim 1, wherein said web browser application is configured to detect a presence of said server application, and to direct to a remote website to download installation files for said server application when said presence of said server application is not detected.

8. The client computer as defined in claim 1, wherein said web browser application is configured to store program code modules through said server application on said computer outside said sandbox and to retrieve from said server application said stored program code modules.

9. The client computer as defined in claim 8, wherein said web browser application comprises a first module that is downloaded from a remote website and executed in said web browser to manage retrieval of said stored program modules, and downloads from said remote website program modules not stored on said computer outside said sandbox.

10. The client computer as defined in claim 9, wherein said web browser application is configured to execute a user interface program from at least one loaded module before loading other modules.

11. The client computer as defined in claim 10, wherein said other modules are loaded as required by execution of said web browser application.

12. The client computer as defined in claim 11, wherein said other modules are all loaded in the background while said at least one loaded module is executing.

13. The client computer as defined in claim 1, wherein said server application is configured to prevent providing access to files outside of said sandbox to unauthorized applications running in said web browser environment.

14. The client computer as defined in claim 1, wherein said web browser application is a photo editing and print order application for editing photo image files on said client computer and transmitting photo images over the Internet for printing at a remote printer location.

15. The client computer as defined in claim 14, wherein photo images are resized to approximately the resolution of a final remote print prior to transmission from said client computer to said remote printer over the Internet.

16. The client computer as defined in claim 14, wherein said photo images are transmitted to said remote printer location with edit commands selected by a user.

17. The client computer as defined in claim 14, wherein said server application is configured to cause data of said photo images to be transmitted to said remote printer independently of said browser application.

18. A network server system communicating with a client computer over the Internet, said server system configured to transmit to said client computer program code modules for putting into effect a web browser application and a server application on said client computer, said client computer comprising:
a web browser environment configured to execute a web browser application in a programming language on said computer, said web browser environment allowing an application to control a writing of files within a sandbox and preventing an application from controlling a writing of files outside said sandbox without using a predetermined browser environment file manager dialog box requiring user input to authorize a file write action;
a server application, installed in said computer by user authentication for execution with access to files stored locally on said computer, said server application configured to communicate with a predetermined web browser application to allow said predetermined web browser application to read and/or write files outside said sandbox on said computer;
wherein said web browser application is configured to execute file write commands for destinations within said sandbox using write commands within said web browser environment, to provide a view of files stored on said computer outside said sandbox without using said predetermined browser environment file manager dialog box, to receive user commands to read and/or write to files using said view, and to execute file read and/or write commands for destinations outside said sandbox by communication through said server application to perform file read and/or write operations outside said sandbox on said computer without using said predetermined browser environment file manager dialog box.
